(19) United States
(12) Patent Application Publication
(10) Pub. No.: US 2020/0217443 A1
(43) Pub. Date: Jul. 9, 2020

(54) INSULATED TUBULAR EXHAUST APPARATUS AND METHODS

(71) Applicant: Nelson Global Products, Inc., Stoughton, WI (US)

(72) Inventors: Scott Lubenow, Fitchburg, WI (US); Carlos A. De Leon Medina, Lake Oswego, OR (US); Rob Schellin, Stoughton, WI (US)

(21) Appl. No.: 16/737,007

(22) Filed: Jan. 8, 2020

Related U.S. Application Data
(60) Provisional application No. 62/789,579, filed on Jan. 8, 2019.

(51) Int. Cl. F16L 59/02; F16L 43/00; F16L 59/11; F01N 13/14

(52) U.S. Cl. CPC F16L 59/021; F01N 13/14; F16L 59/11; F16L 43/001

(57) ABSTRACT

A bent tube with a sleeve of insulation and a protective outer metallic layer and related methods of manufacturing.

### CROSS REFERENCE TO RELATED APPLICATION

This application claims the benefit of U.S. Provisional Application No. 62/789,579, filed Jan. 8, 2019, the disclosures of which is incorporated by reference herein.

### FIELD AND BACKGROUND OF THE INVENTION

This invention relates generally to insulated tubes and insulated tube construction methods.

In the automotive industry, exhaust tubes are insulated to retain heat and thereby improve exhaust efficiencies and emissions, as well as protect nearby vehicle components and personnel. Many types of insulation and manufacturing methods are known, but many are difficult and costly to manufacture.

Further, tube insulation tends to be less efficient wherever tubes bend, or have connectors or other protuberances that interfere with the insulation, causing the insulation the be less effective and more difficult to apply at such locations.

Manufacturing exhaust tubes can be time consuming and expensive because the process typically requires hand assembly and multiple steps. In one example, an exhaust tube is wrapped with a sheet of insulating material that matches the length of the tube. The wrapped sheet results in a longitudinal seam along the tube that is taped or wrapped to hold the edges of the sheet together and form a seam while an outer protective cover is applied. This approach is successful in insulating the tube, but is time-consuming and difficult to assemble. Errors or slippage can result in gaps along the seam of the insulation.

Another example disclosed in U.S. Pat. No. 9,976,687 B2 uses a braided sleeve over a tube, but then uses a slurry of resin and fibers applied to the sleeve that must then be dried or baked to solidify and retain its shape. This method is time-consuming and difficult to execute.

Other examples of such exhaust tube insulations and methods of manufacturing are disclosed in: U.S. Patent Application Publication No. 2018/0238221 published Aug. 23, 2018; U.S. Pat. No. 10,329,991 issued Jun. 25, 2019; International Publication No. WO 2017/181197 published Oct. 19, 2017; U.S. Patent Application Publication No. 2016/0311152 published Oct. 27, 2016; U.S. Pat. No. 9,388,515 issued Jul. 12, 2016; International Publication No. WO 97/32067 published Sep. 4, 1997; U.S. Patent Application Publication No. 2010/0154917 published Jun. 24, 2010; U.S. Pat. No. 4,287,245 issued Sep. 1, 1981; U.S. Pat. 6,000,438 issued Dec. 14, 1999; U.S. Pat. No. 6,403,180 issued Jun. 11, 2002; U.S. Patent Application Publication No. 2007/0102055 published May 10, 2007; German Patent Publication 10 2010 028 433 published Nov. 3, 2011; U.S. Pat. No. 8,950,168 issued Feb. 10, 2015; and U.S. Patent Application Publication No. 2007/0049148 published Mar. 1, 2007.

Thus, there is a need for improved tube insulation and manufacturing methods that provide uniform insulation, including at bends and protuberances of the tubes, which can be accomplished efficiently during the manufacturing process.

### SUMMARY OF THE INVENTION

The present invention provides a uniform tube insulation, and efficient and inexpensive method of manufacturing tubular insulation. In accordance with the present invention, a method for manufacturing an insulated vehicle exhaust tube, includes the steps of: sliding an insulating sleeve over an exhaust tube section; adjusting the insulating sleeve to a substantially uniform material thickness over the pipe section; restraining the ends of the insulating sleeve relative to the exhaust tube section; allowing a central portion of the insulating sleeve to remain unrestrained relative to the tube section; and enclosing the insulating sleeve with a metal protective cover. Preferably, the insulating sleeve is a braided material that slides over the tube from one end. It is also possible to have more than one insulating sleeve with the insulating sleeves positioned end-to-end or in layers.

The metal protective cover can be texturized and be a thin foil to resist denting, creasing, and other deformities. As stated above, more than one insulating sleeve can be used to improve insulation properties and temperature retention in the tube, and the layered insulating sleeves can be adjusted to provide relatively uniform and seamless insulation for the exhaust tube.

In the method, the step of restraining the ends of the insulating sleeve can include the step of: wrapping end portions of the insulating sleeve with a restraining material such as a plastic or fabric wrap.

Further, the step of restraining the ends of the insulating sleeve can include the steps of: wrapping end portions of the insulating sleeve with a restraining material; and trimming excess end portions of the insulating sleeve that extend outwardly beyond the restraining material. Another option for the step of restraining the ends of the insulating sleeve includes the step of: wrapping end portions of the insulating sleeve with tape, or the step of: wrapping end portions of the insulating sleeve with a sheet material free of adhesives.

Other features and advantages of the present invention are described below in the Detailed Description of the Invention.

### BRIEF DESCRIPTION OF THE DRAWINGS

FIG. 1 is a perspective view of a bent tube with an insulating sleeve wrapped around a portion of the bent tube, in accordance with the present invention;

FIG. 2 is a perspective view of a bent tube partially wrapped in an insulating sleeve and a restraining sheet;

FIG. 3 is a perspective view of a bent tube with an insulating sleeve wrapped in a textured foil, in accordance with the present invention;

FIG. 4 is a partial perspective view of the bent tube of FIG. 3;

FIG. 5 is an end view of a bent tube wrapped in an insulating sleeve and a textured foil outer layer, in accordance with the present invention;

FIG. 6 is a perspective view with a partial cutaway of layers of a bent tube with two layers of insulating sleeve in accordance with the present invention; and

FIG. 7 is a cross-sectional view of the bent tube taken along line 7-7 of FIG. 6.

### DETAILED DESCRIPTION OF THE INVENTION

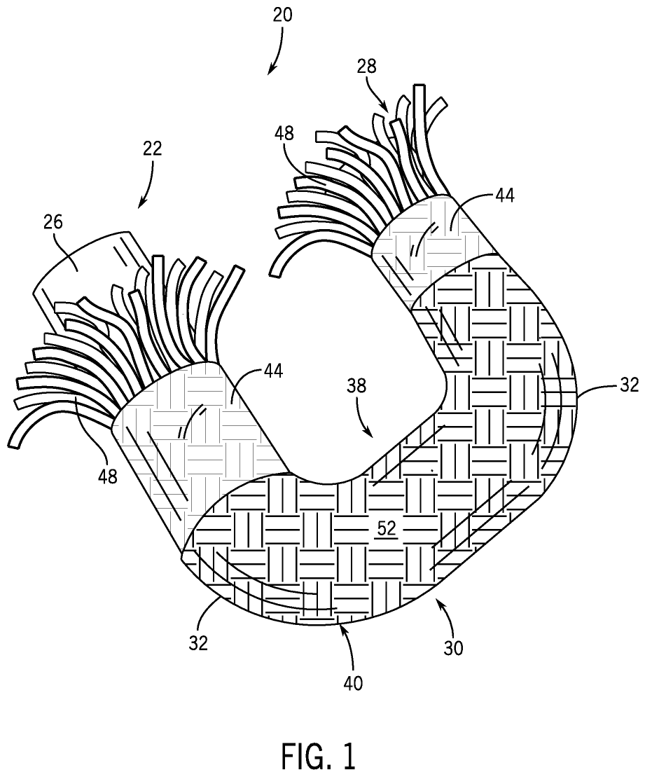

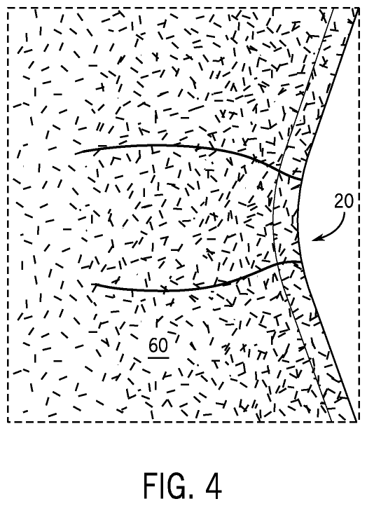

FIGS. 1 through 4 depict an insulated tube 20 in a sequence of steps in a method of manufacturing of the insulated tube 20. The insulated tube 20 includes an exhaust tube 22 having a first end 26, a second end 28, and a central portion 30. The illustrated central portion 30 includes optional bends 32. The exhaust tube 22 defines a conduit through which exhaust gases flow from an engine to any type of downstream exhaust component. The exhaust tube 22 is preferably rigid, but flexible exhaust tubes 22 can also be used. Further, the exhaust tube 22 may have ends that are reinforced with rims that are formed in the exhaust tube 22 or added before the insulation is installed.

The insulated tube 20 can be used in any type of vehicle on which insulated exhaust tubes are desirable, including those applications where insulation was once considered too expensive because the present invention saves considerable expense in materials and manufacturing.

FIG. 1 illustrates an early stage of the manufacturing process in which the step of sliding an insulating sleeve 36 over the exhaust tube 22 has been performed. The insulating sleeve 36 described herein is a braided sleeve 36, which is preferred because it is relatively easy to manipulate and bring into position over the exhaust tube 22 to have a relatively uniform thickness even around the bends 32. Of course, the internal area 38 of the bend 32 will have a more condensed amount of the insulating sleeve 36 than an outer area 40 of the bend 32, but both areas 38 and 40 will have ample insulating coverage when the insulating sleeve 36 is used. This provides a “substantially uniform material thickness” for insulating the exhaust tube 22, even when using a tubular insulating sleeve 36. Further, sleeves of insulating material 36 can be pre-cut to match the shape of the exhaust tube 22. Preferably, the insulating sleeve 36 is made of a high temperature insulation fiber, ceramic glass, or other suitable materials, and is preferably braided, as described herein. Nonetheless, other sleeve constructions are possible, including woven, non-woven, extruded, or any other material that slides over the end of the tube 20 and is manipulated into the desired position.

Also seen in FIG. 1 is a restraining material 44 which is preferably wrapped around end portions 46 of the braided sleeve 36 and restrains the end portions 46 from excessive movement during the remainder of the manufacturing process. The restraining material 44 can also be wrapped around all portions of the braided sleeve 36, or just a central portion while the end portions 46 are left unrestrained. The restraining material 44 is preferably made of plastic wrap, zip tie, metal, clips, fabric, or other suitable material.

An extra portion 48 of the insulating sleeve 36 may result from cutting, installing, and positioning the insulating sleeve 36. The restraining material 44 can hold some of the extra portion 48 in place, while an unrestrained portion extends outwardly. The unrestrained extra portion 48 is illustrated as a frayed portion, but it can be any extra material that is not needed on the portion of the insulated tube 20, and is rolled over or tucked in, or is preferably trimmed off using a rotary cutter, scissors, knife, or other device. The ends of the insulating sleeve 36 can also be prepared in any suitable manner before installation to prevent or reduce fraying.

In the illustrated embodiment, a central portion 52 of the insulating sleeve 36 is not wrapped and is permitted to be unrestrained, at least temporarily, to allow for readjustment of the braided sleeve 36, for example, before further manufacturing steps are performed. Restraining only a portion of the insulating sleeve 36, such as the end portions 46, anchors the insulating sleeve 36 while the remaining portions, such as the central portion 52, are adjusted as necessary to accommodate the shape of the exhaust tube 22, and simplifies the production of the insulated tube 20.

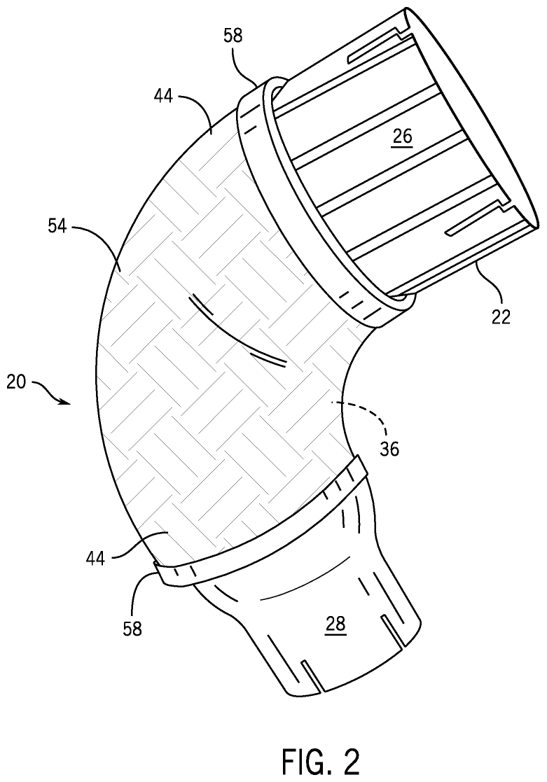

Once the insulating sleeve 36 is adjusted into a desired position of a substantially uniform thickness, the central portion 52 can be wrapped with a restraining wrap 54, as seen in FIG. 2, for example. Other types of restraining wraps 54 can be used, as can adhesives, as described above.

Depicted in FIG. 2, is a collar 58 on each end of the insulated central portion 30. One collar 52 can be used, but it is preferred to use two, as illustrated. The collars 58 are preferably attached directly to the exhaust tube 22 using any suitable method, such as welding, adhesives, mechanical fasteners, for example. Further, the collars 58 can be attached before or after the insulating sleeve 36 is installed on the exhaust tube 22. The collars 58 can also be positioned over the ends of the insulating sleeve 36 to restrain the ends of the insulating sleeve 36. The collars 58 can be ring-shaped and fitted over the exhaust tube 22 from the ends or the collars 58 can be formed of a number of segments that are hinged together or assembled on the exhaust tube 22.

The collars 58 extend outwardly from the exhaust tube 22 a distance that preferably matches the thickness of the insulating sleeve 36, but other collar dimensions are possible, particularly to accommodate the thickness of any restraining material 44 or additional insulation layers (see below) being used. Also preferably, the collars 58 are joined to the exhaust tube 22 to provide reinforcement for the exhaust tube 22.

After the insulating sleeve 36 is properly positioned, and any restraining material 44 is applied, a protective cover 60 is added around the outside. The protective cover 60 is preferably metal and is attached to the collars 58 when they are used, but the protective cover 60 can be tapered or stepped down and attached directly to the exhaust tube 22 at the ends. The attachment can be made with welds, adhesives, and mechanical fasteners, as examples.

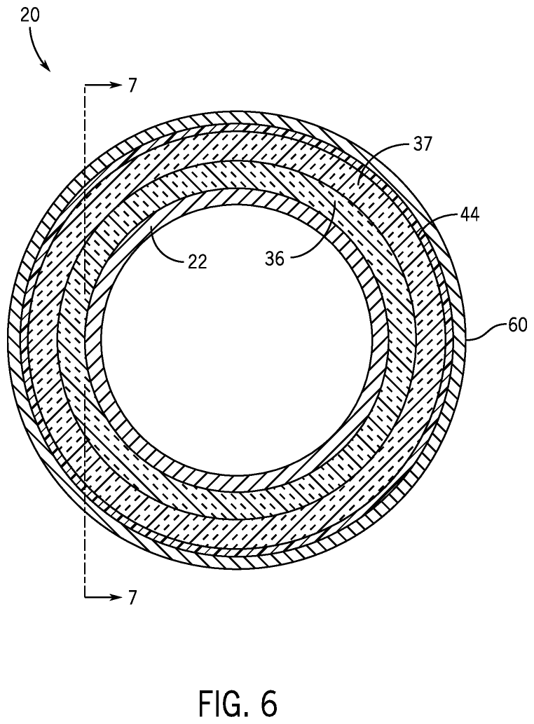

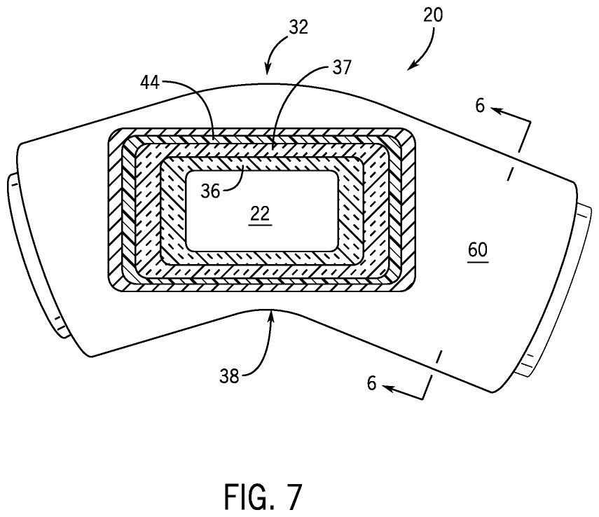

FIGS. 6 and 7 illustrate an alternate embodiment having multiple layers of insulating sleeves. In this illustrated embodiment, a first layer of insulating sleeve 36 is illustrated adjacent to the exhaust tube 22. A second layer of insulating sleeve 37 is illustrated around the first layer of insulating sleeve 36 to improve heat retention in the exhaust tube 22. Additional layers of insulating sleeves can be added as well. This embodiment can also include a restraining wrap 44, as described above. Restraining wrap 44 can be used on each layer of insulating sleeves, if desired, or only around the outer most layer of insulating sleeve 37. Preferably, an outer metal protective cover 60 and collars 58 are also used in this embodiment.

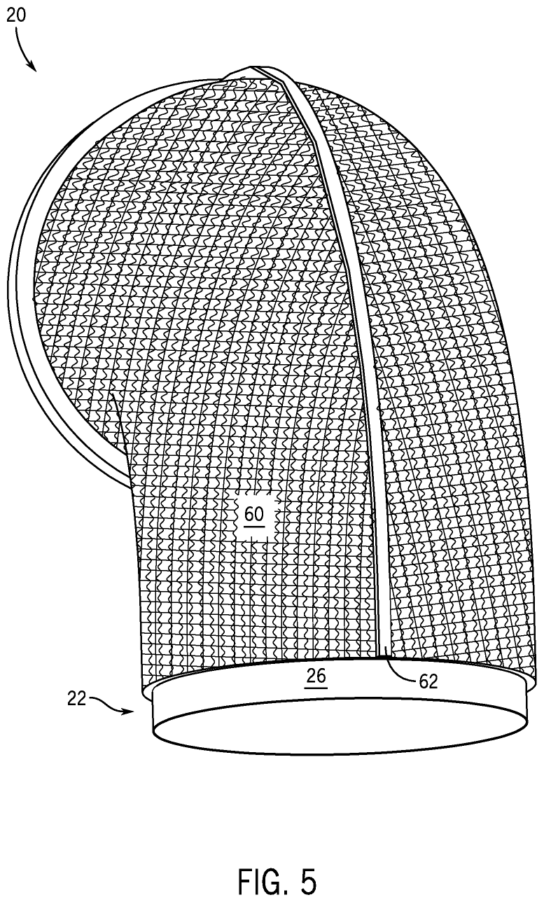

The metal protective cover 60 can be a tubular sleeve or a sheet wrapped around and secured to itself at a crimp 62, as seen in FIG. 5. Preferably, the metal protective cover 60 is a thin foil that is easily wrapped and secured to form a sleeve to provide light weight protection for the insulating sleeve. “Thin” foil is defined herein as being 0.012 inches thick or less. Preferably, 0.004 inch thick or 0.008 inch thick foil is used in the present invention. Other metal covers could be thicker, including a metal sheet 0.057 inches thick. The metal covers 60 can also be bent tubes which are cut, placed over the insulating sleeve 36 and rewelded together. Stamped covers and cover segments can also be used.

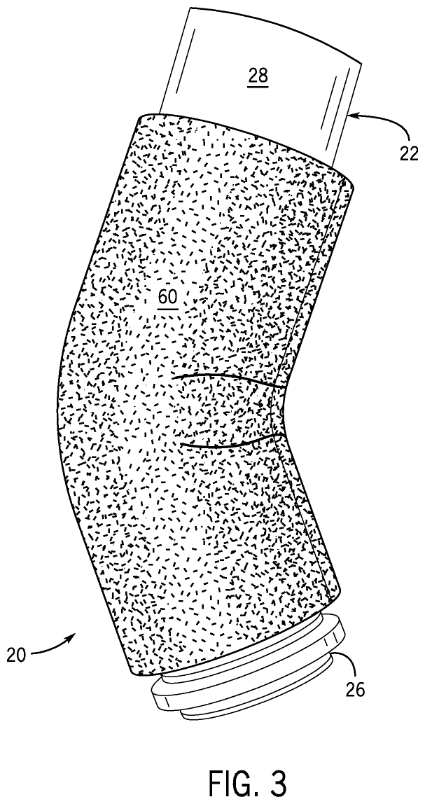

Also, preferably the metal protective cover 60 is textured to provide increased rigidity and resistance to creases and wrinkles, for example, as well as any desired ornamental features. Any suitable texture can be employed. Optionally, the outer protective cover can include: insulated wire mesh sleeve; insulated wire mesh wrap; wrapped mesh screen; stamped foil; wrapped foil; duct tape; metal/foil tape; and wire braid, as well as those depicted in FIGS. 3 to 5, for example, and such as a waffle or “elephant skin” pattern. Combinations of various types of outer covers can also be used, either in layers or with different types of outer layers wrapped around different portions of the insulated tube 20.

The above detailed description is provided for understanding the depicted embodiments of the present invention, and no unnecessary limitations therefrom should be read into the following claims.

1. A method for manufacturing an insulated vehicle exhaust tube, the method comprising the steps of:
sliding an insulating sleeve over an exhaust tube;
adjusting the insulating sleeve to a substantially uniform material thickness over the tube; and
enclosing the insulating sleeve with a metal protective cover.

2. The method of claim 1, and further comprising the steps of:
restraining an end portion of the insulating sleeve relative to the exhaust tube; and
allowing a central portion of the insulating sleeve to remain unrestrained relative to the exhaust tube.

3. The method of claim 1, and further comprising the steps of:
restraining a first portion of the insulating sleeve relative to the exhaust tube; and
allowing a second portion of the insulating sleeve to remain unrestrained relative to the exhaust tube.

4. The method of claim 1, wherein the insulating sleeve comprises a braided material.

5. The method of claim 1, wherein the metal protective cover is texturized.

6. The method of claim 1, wherein the metal protective cover is thin foil.

7. The method of claim 3, wherein the step of restraining the first portion of the insulating sleeve comprises the step of:
wrapping the first portion of the insulating sleeve with a restraining material.

8. The method of claim 2, wherein the step of restraining the end portion of the insulating sleeve comprises the steps of:
wrapping the end portion of the insulating sleeve with a restraining material; and
trimming excess end portions of the insulating sleeve that extend outwardly beyond the restraining material.

9. The method of claim 3, wherein the step of restraining the first portion of the insulating sleeve comprises the step of:
wrapping the first portion of the insulating sleeve with tape.

10. The method of claim 3, wherein the step of restraining the first portion of the insulating sleeve comprises the step of:
wrapping the first portion of the insulating sleeve with a restraining material free of adhesives.

11. The method of claim 1, and further comprising the steps of:
attaching a collar to the exhaust tube; and
attaching the metal protective cover to the collar.

12. The method of claim 1, and further comprising the steps of:
attaching a pair of collars to the exhaust tube to define a space for the insulating sleeve; and
attaching end portions of the metal protective cover to each collar.

13. The method of claim 1, and further comprising the steps of:
sliding a second insulating sleeve over the insulating sleeve; and
adjusting the second insulating sleeve to a substantially uniform thickness.

14. An insulated exhaust tube comprising:
an exhaust tube;
an insulating sleeve wrapped around at least a portion of the exhaust tube; and
a protective metal cover disposed around the insulating sleeve.

15. The insulated exhaust tube of claim 14, and further comprising:
a restraining material in restraining engagement with an end portion of the insulating sleeve.

16. The insulated exhaust tube of claim 14, and further comprising:
a restraining material in restraining engagement with a portion of the insulating sleeve.

17. The insulated exhaust tube of claim 14, wherein the insulating sleeve is trimmed to substantially match an edge of the restraining material.

18. The insulated exhaust tube of claim 14, wherein the insulating sleeve comprises a braided material.

19. The insulated exhaust tube of claim 16, wherein:
the restraining material comprises:
flexible plastic.

20. The insulated exhaust tube of claim 14, wherein the protective metal cover is embossed.

21. The insulated exhaust tube of claim 14, and further comprising:
a collar joined to the exhaust tube to define an end location for the insulating sleeve.

22. The insulated exhaust tube of claim 14, and further comprising:
a collar joined to the exhaust tube to define an end location for the insulating sleeve; and
a pair of collars joined to the exhaust tube and spaced apart to define a space in which the insulating sleeve is at least partially disposed.

23. The insulated exhaust tube of claim 14, and further comprising:
a second insulating sleeve wrapped around the insulating sleeve.
